(19) United States
(12) Patent Application Publication
(10) Pub. No.: US 2026/0105791 A1
(43) Pub. Date: Apr. 16, 2026

(54) MOBILE DEVICE USER INTERFACE AND TELEMETRY FOR ON-VEHICLE ELECTRO-PNEUMATIC CONTROL AND MONITORING

(71) Applicant: AKTV8 LLC, Wixom, MI (US)

(72) Inventors: Joshua Coombs, East Lansing, MI (US); Gary Meyers, Wixom, MI (US); Thomas Ganss, Whitmore Lake, MI (US); Timothy O'Connell, Milford, MI (US)

(21) Appl. No.: 19/360,666

(22) Filed: Oct. 16, 2025

Related U.S. Application Data
(60) Provisional application No. 63/707,784, filed on Oct. 16, 2024.

(51) Int. Cl. G07C 5/08; B60C 23/04; B60T 17/22; G07C 5/00

(52) U.S. Cl. CPC G07C 5/0825; B60C 23/0479; B60T 17/22; G07C 5/008; G07C 5/085; G07C 2205/02

(57) ABSTRACT

An electro-pneumatic control system for a vehicle includes: a plurality of sensors, each configured to detect at least one physical characteristic of the electro-pneumatic control system; and a mobile device in communication with the plurality of sensors for receiving data regarding the at least one physical characteristic of the electro-pneumatic control system. The mobile device includes a user interface presenting a dashboard page having a plurality of status indicators. Each status indicator represents a corresponding subsystem of the vehicle. The mobile device is configured to change a visual appearance of each status indicator of the plurality of status indicators to indicate a condition of the corresponding subsystem of the vehicle. The mobile device is configured to detect a user selection of each status indicator and to present a system detail screen for a given subsystem in response to detecting the user selection of a corresponding status indicator.

### CROSS-REFERENCE TO RELATED APPLICATIONS

This U.S. utility patent application claims the benefit of U.S. Provisional Ser. No. 63/707,784 filed Oct. 16, 2024, the contents of which is incorporated herein by reference in its entirety.

### FIELD

The present invention relates to an application for a mobile device, such as a smartphone or tablet that provides user interface (UI) and telemetry functionality for on-vehicle electro-pneumatic controllers and/or sensors, and for configuring such controllers and/or sensors for one or more vehicles.

### BACKGROUND

Applications, also called “apps” are packages of software that may be run on a mobile device, such as a smartphone or tablet. Apps may provide a variety of functionality and capabilities to such mobile devices.

### SUMMARY

The present disclosure provides an electro-pneumatic control system for a vehicle. The electro-pneumatic control system includes: a plurality of sensors, each configured to detect at least one physical characteristic of the electro-pneumatic control system; and a mobile device in communication with the plurality of sensors for receiving data regarding the at least one physical characteristic of the electro-pneumatic control system. The mobile device includes a user interface presenting a dashboard page having a plurality of status indicators, each representing a corresponding subsystem of the vehicle. The mobile device is configured to change a visual appearance of each status indicator of the plurality of status indicators to indicate a condition of the corresponding subsystem of the vehicle. The mobile device is configured to detect a user selection of each status indicator of the plurality of status indicators. The mobile device is further configured to present a system detail screen for a given subsystem in response to detecting the user selection of a corresponding status indicator of the plurality of status indicators.

The present disclosure also provides an electro-pneumatic control system for a vehicle that includes: a first electronic control unit configured to control a first pneumatic function; a second electronic control unit configured to control a second pneumatic function; and a mobile device in communication with each of the first electronic control unit and the second electronic control unit for receiving data regarding each of the first pneumatic function and the second pneumatic function. The mobile device includes a user interface presenting a dashboard page having a plurality of status indicators, each representing a corresponding system, The mobile device is configured to change a visual appearance of each status indicator of the plurality of status indicators to indicate a condition of the corresponding system.

The present disclosure also provides an electro-pneumatic monitoring system. The electro-pneumatic monitoring system includes: a plurality of sensors, each configured to detect at least one physical characteristic of an electro-pneumatic system of a vehicle; and a mobile device located in the vehicle in communication with the plurality of sensors for receiving data regarding the at least one physical characteristic of the electro-pneumatic system. The mobile device is configured to transmit status data regarding the electro-pneumatic system to a remote computer. The remote computer includes a user interface presenting a dashboard page having a plurality of status indicators, each representing a corresponding system of the vehicle. The remote computer is configured to change a visual appearance of each status indicator of the plurality of status indicators to indicate a condition of the corresponding system.

These and other aspects of the present disclosure are disclosed in the following detailed description of the embodiments, the appended claims, and the accompanying figures.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 shows a schematic block diagram of a system in accordance with aspects of the present disclosure.

FIG. 2 presents a schematic diagram of a system, in accordance with aspects of the present disclosure.

FIG. 3 presents a dashboard page of a user interface of an app. for a mobile device, in accordance with an aspect of the present disclosure.

FIG. 4 presents a first set of screens of the app., in accordance with aspects of the present disclosure.

FIGS. 5-7 present a second set of screens of the app., in accordance with aspects of the present disclosure.

FIG. 8 presents a TPMS setting screen of the app., in accordance with aspects of the present disclosure.

FIG. 9 presents a load configuration setting screen of the app., in accordance with aspects of the present disclosure.

FIG. 10 presents a schematic diagram of a semi-tractor and trailer, showing additional sensors monitored by a system, in accordance with aspects of the present disclosure.

### DESCRIPTION OF THE ENABLING EMBODIMENTS

Referring to the Figures, wherein like numerals indicate corresponding parts throughout the several views, a system 20 for configuring and monitoring one or more vehicle-based electro-pneumatic controllers and/or sensors, and for configuring such controllers and/or sensors for one or more vehicles controllers for lift, height, and load distribution and control and for tire pressure monitoring and control is provided. The system 20 may be called an electro-pneumatic monitoring system.

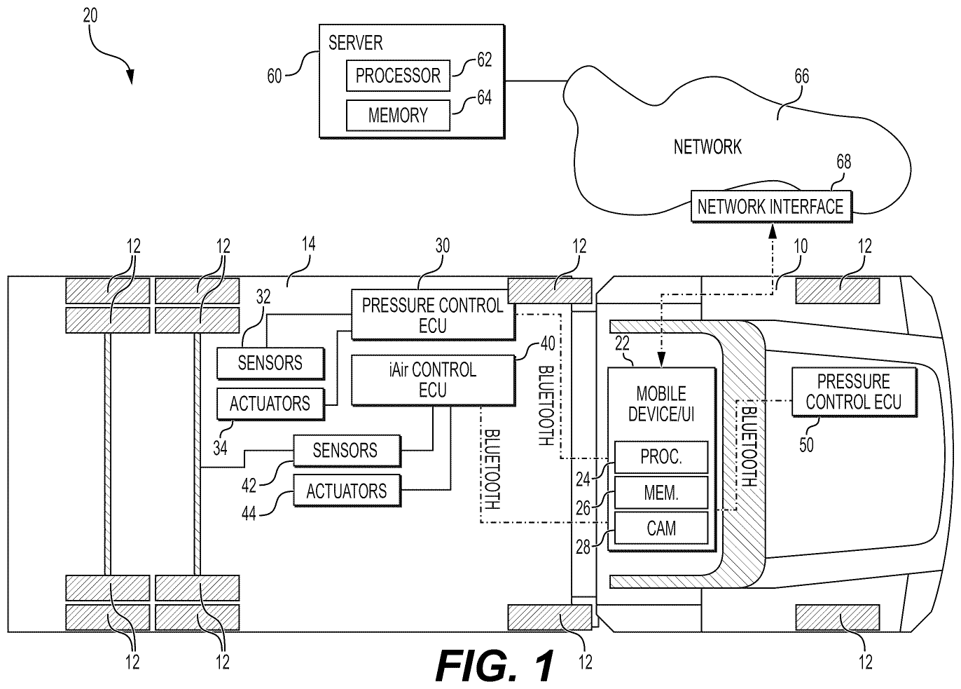

As shown in FIG. 1, the system 20 includes a tractor/trailer 10, 14 having a plurality of tires 12. The tractor/trailer 10, 14 includes a tractor 10, which may also be called a truck or a semi-tractor, having an engine and a cab for a driver to operate the tractor/trailer 10, 14. The tractor/trailer 10, 14 also includes a trailer 14 that is detachably coupled to the tractor 10. The system 20 also includes a mobile device 22, such as a smartphone or a tablet, which presents a user interface for use by an operator, such as a driver of the tractor/trailer 10, 14. In some embodiments, the mobile device 22 may be mounted or fixed within a cab of the tractor 10. Alternatively or additionally, the mobile device 22 may be removable to be carried by the operator.

The mobile device 22 includes a processor 24 and a machine-readable storage memory 26 that contains an application program, which may be called an app., for execution by the processor 24 and to provide the functionality described herein. The mobile device 22 may include a user interface, such as a touch screen, a speaker, a microphone, and/or a connection to one or more external devices, for presenting information to the operator and for receiving input data from the operator.

The system 20 also includes a first electrical control unit (ECU) 30, which may be called a pressure control ECU, located on the trailer 14 and which is electrically connected to one or more first sensors 32 and/or one or more first actuators 34. The first ECU 30 may control lifting, height, and/or load distribution in the trailer 14. For example, the first sensors 32 may include a height sensor and/or one or more pressure sensors. The first actuators 34 may include one or more solenoid valves and/or air pumps. The first ECU 30 may command the first actuators 34 to cause the first actuators 34 to be in a certain configuration and to cause an air suspension and/or a lift axle to be in a given position based on sensors from the first sensors 32. The first ECU 30 may be in communication with the mobile device 22 to provide status information to the mobile device 22 and/or to receive setting data from the mobile device 22.

The system 20 also includes a second ECU 40, which may be called a tire inflation control ECU, located on the trailer 14 and which is electrically connected to one or more second sensors 42 and/or one or more second actuators 44. The second ECU 40 may control tire pressure in the trailer 14. For example, the second sensors 42 may include one or more tire pressure sensors and/or temperature sensors. The second actuators 44 may include one or more solenoid valves and/or air pumps. The second ECU 40 may command the second actuators 44 to cause the second actuators 44 to be in a certain configuration and to cause air to be supplied for inflating the tires 12 based on sensors from the second sensors 42. The second ECU 40 may be in communication with the mobile device 22 to provide status information to the mobile device 22 and/or to receive setting data from the mobile device 22.

The system 20 also includes a third ECU 50, which may be called a pressure control ECU, located on the truck 10. The third ECU 50 may be similar or identical to the first ECU 30 and/or the second ECU 40, except associated with components on the tractor 10 instead of the trailer 14. The third ECU 50 may be in communication with the mobile device 22 to provide status information to the mobile device 22 and/or to receive setting data from the mobile device 22.

The system 20 also includes a server 60 having a second processor 62 and a second machine-readable storage memory 64 and which is in communication with the mobile device 22 via a network 66 and one or more network interfaces 68. The server 60 may store, on the second machine-readable storage memory 64 data from the ECUs 30, 40, 50 or from the mobile device 22. The server 60 may include two or more processors, which may be located together or distributed. In some embodiments, the second processor 62 may execute program instructions to provide back-end functionality, such as data storage and retrieval. The one or more network interfaces 68 may include a long term evolution (LTE) cellular data modem. However, other types of communications interfaces, such as other cellular data standards, vehicle-to-everything (V2X), peer-to-peer, satellite-based communications, Ethernet, etc. may be used.

In some embodiments, the server 60 and/or one or more other processors may implement an artificial intelligence (AI), which may be configured, for example, to analyze photos and/or video regarding one or more vehicles in order to determine a configuration of the one or more vehicles. The configuration may include, for example, a vehicle name and type (trailer or tractor, number of axles, etc.) The configuration may include additional information regarding a number and type of tires and/or a number and type of axles (liftable or static).

The app. running on the mobile device 22 may integrate multiple control systems and sensors into one “hub.” The app. may interface via Bluetooth to all our sensors and systems, allowing a customer to easily configure each system, view data, and control functions. However, other types of wired and/or wireless data interfaces may be used, such as Bluetooth low energy (BLE) Wi-Fi, ZigBee, or other short-range or medium-range communications interface.

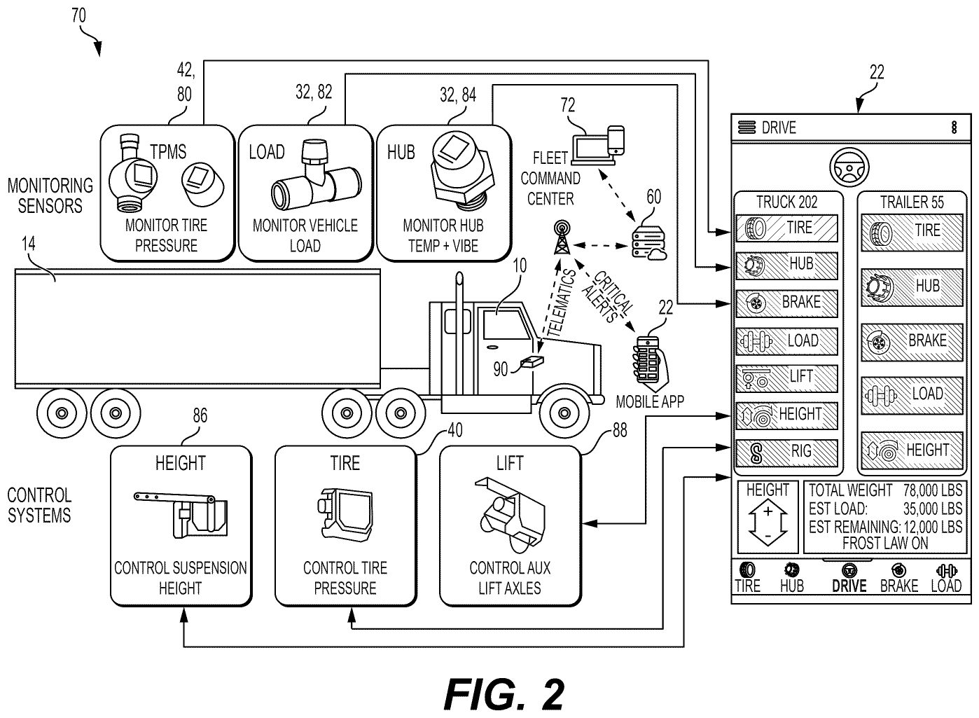

FIG. 2 presents a schematic diagram of a system 70, in accordance with aspects of the present disclosure. As shown, the mobile device 22 receives data from a plurality of the sensors 32, 42, including the first sensors 32, and the second sensors, 42, and third sensors 82. The second sensors 42 include tire pressure monitoring system (TPMS) sensors 80 which monitor tire pressure in one or more tires. For example, each tire 12 may have a dedicated TPMS sensor 80. Alternatively or additionally, two of the tires 12 on one side of an axle may be connected to single TPMS sensor 80 via a Tee fitting. The first sensors 32 include load sensors 82 which monitor air pressure in one or more air springs for monitoring the load carried by one or more axles. The first sensors 32 also include hub sensors 84 that monitor temperature and/or vibration of a hub where one or more wheels are connected to an axle.

FIG. 2 also shows the mobile device 22 in bi-directional communication with several control systems 40, 86, 88. Each of those control systems 40, 86, 88 may include one or more sensors and/or actuators. The second ECU 40 is in bi-directional communication with the mobile device 22 for controlling tire pressure in the trailer 14. A suspension height control system 86 is also in bi-directional communication with the mobile device 22 for controlling ride height of suspension components. The suspension height control system 86 may include one or more sensors and/or actuators, such as a height sensor, which may be integrated with the first ECU 30. However, the height sensor may additionally or alternatively be implemented as a stand-alone device that communicates measured height to the mobile device 22 via the first ECU 30. The suspension height control system 86 may be controlled by the first ECU 30. However, the suspension height control system 86 may be controlled independently. A lift axle control system 88 is also in bi-directional communication with the mobile device 22 for controlling deployment and retraction of one or more auxiliary lift axles. The lift axle control system 88 may be controlled by the first ECU 30. However, lift axle control system 88 may be controlled independently.

The system 70 shown on FIG. 2 also includes a transponder 90 located in the tractor/trailer 10, 14 for transmitting telematics data to the server 60 and/or to the mobile device 22. The transponder 90 may collect and forward data from each of the ECUs 30, 40, 50. In some embodiments, the mobile device 22 may function as the transponder 90. The system 70 also includes a fleet command center computer 72 that collects and presents data regarding one or more tractor/trailers 10, 14 of a given fleet, which may be operated or otherwise coordinated by a company or other entity.

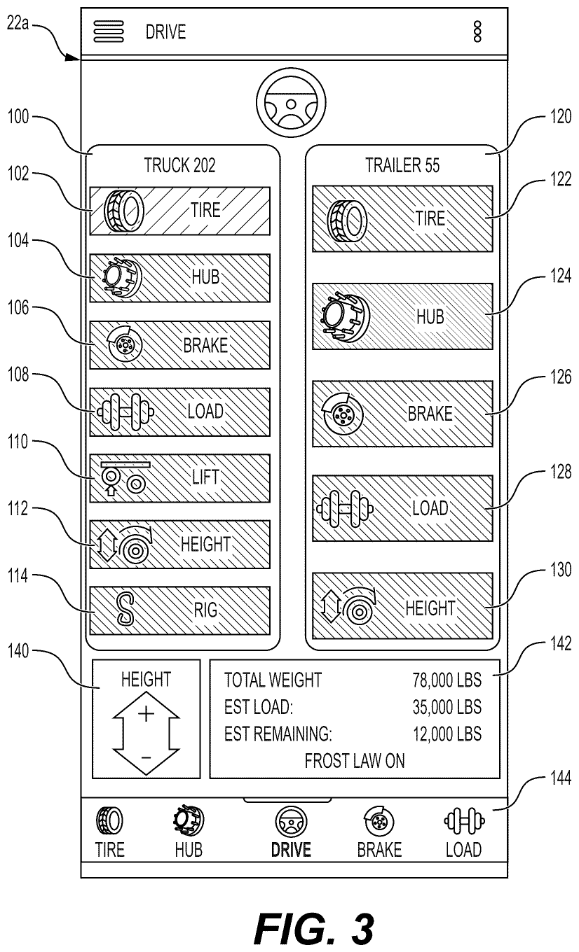

FIG. 3 presents a dashboard page 22a, which may also be called a “Drive” screen, presented by the app. on the user interface of the mobile device 22. The dashboard page 22a includes a first group 100 with a label “TRUCK 202” that signifies a particular truck or semi-tractor (i.e. truck number 202). The dashboard page 22a also includes a second group 120 with a label “TRAILER 55” that signifies a particular trailer (i.e. trailer number 55). The first group 100 includes a first plurality of status indicators 102, 104, 106, 108, 110, 112, and 114, each representing a corresponding subsystem of that particular truck. The second group 120 includes a second plurality of status indicators 122, 124, 126, 128, and 130, each representing a corresponding subsystem of that particular trailer. Status indicators 102 and 112 each indicate a condition of the tire pressure monitoring of a corresponding one of the truck or trailer. Status indicators 104 and 114 each indicate a condition of the hubs of a corresponding one of the truck or trailer. Status indicators 106 and 116 each indicate a condition of the brakes of a corresponding one of the truck or trailer. Status indicators 108 and 118 each indicate a condition of the load of a corresponding one of the truck or trailer. Status indicators 110 and 130 each indicate a condition of the height of a corresponding one of the truck or trailer. Status indicator 114 indicates a condition of cargo rigging on the truck.

Each of the status indicators 102, 104, 106, 108, 110, 112, 114, 122, 124, 126, 128, and 130 may have a color and/or other visual indication, such as brightness, intensity, blinking, animation, etc., to indicate a status of a corresponding subsystem. For example, each of the status indicators 102, 104, 106, 108, 110, 112, 114, 122, 124, 126, 128, and 130 may be white or green to indicate condition of the corresponding subsystem of the vehicle as being good or acceptable for use. Each of the status indicators 102, 104, 106, 108, 110, 112, 114, 122, 124, 126, 128, and 130 may be yellow to indicate the corresponding subsystem of the vehicle as having a warning condition, or red to indicate the corresponding subsystem of the vehicle having a faulted condition.

The dashboard page 22a brings all the systems together to make a single User interface that has “health/access buttons” for each system on each vehicle (truck+trailer). Each button can be green/yellow/red to show status, allowing the User a quick snapshot of vehicle health: if all green, drive—your vehicle is OK; if yellow, monitor to see if ok; if red, pull over and check (tire blowout, hub overheat, overloaded, etc.) The dashboard page 22a allows a user to touch any button to immediately access more detail of that system.

The dashboard page 22a also includes a height control interface 140 with up and down buttons that may allow an operator to quickly adjust a height of the tractor/trailer 10, 14. The dashboard page 22a also includes a weight reporting interface 142 with indicators of total weight of the tractor/trailer 10, 14, an estimated load weight, and an estimated remaining weight for compliance with applicable restrictions. The weight reporting interface 142 also includes an indicator “FROST LAW ON”, showing that a frost law is in effect, which may impact the applicable weight restriction. Information regarding the applicable restrictions may be provided to the mobile device 22 by the server 60, based on a current location and/or planned route of the tractor/trailer 10, 14. The dashboard page 22a also includes a navigation bar 144 along a lower edge of the screen with links to each of: the dashboard page 22a, labeled “DRIVE”; a tire status page 22b, labeled “TIRE”; a hub status page 22c, labeled “HUB”; a brake status page 22d, labeled “BRAKE”; and a load status screen 22e, labeled “LOAD. ”

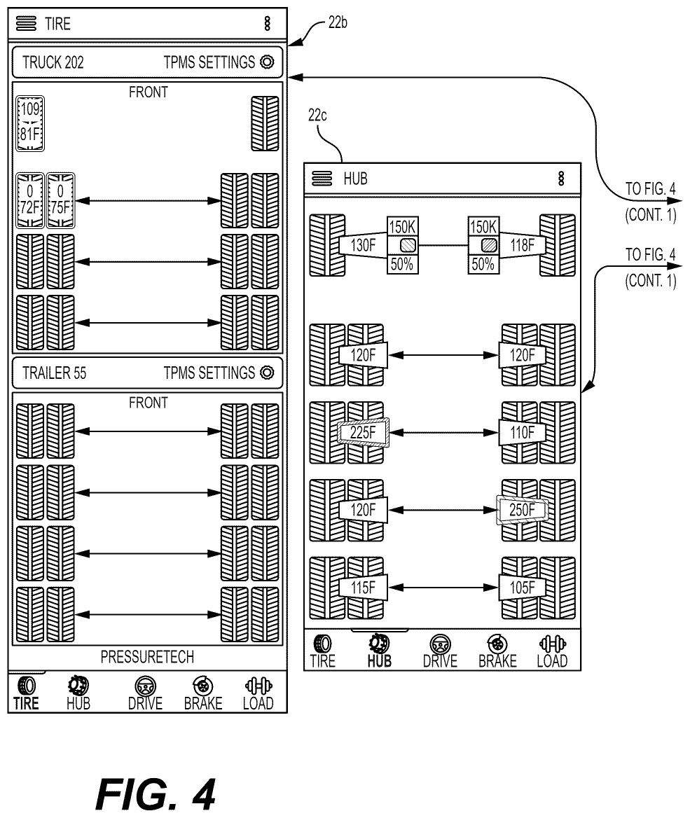

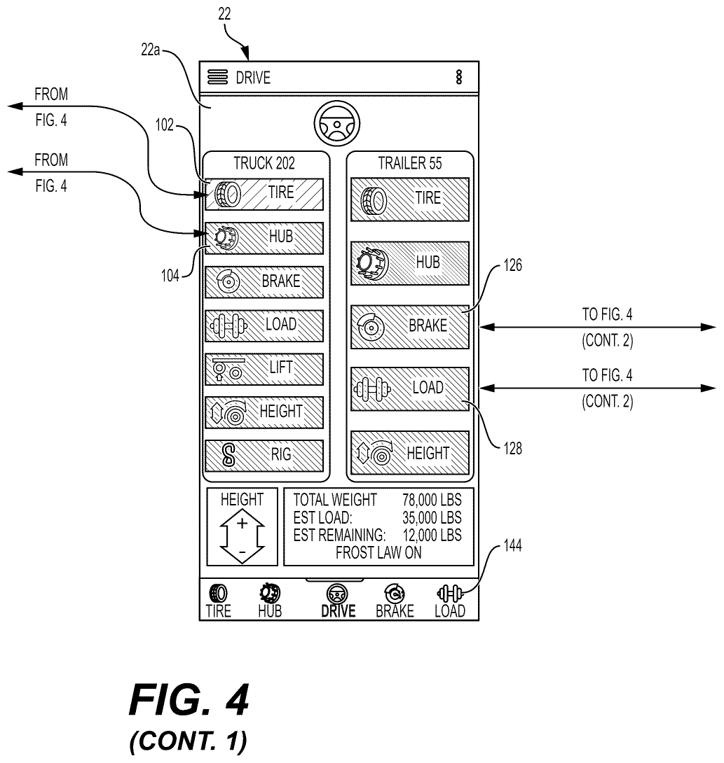

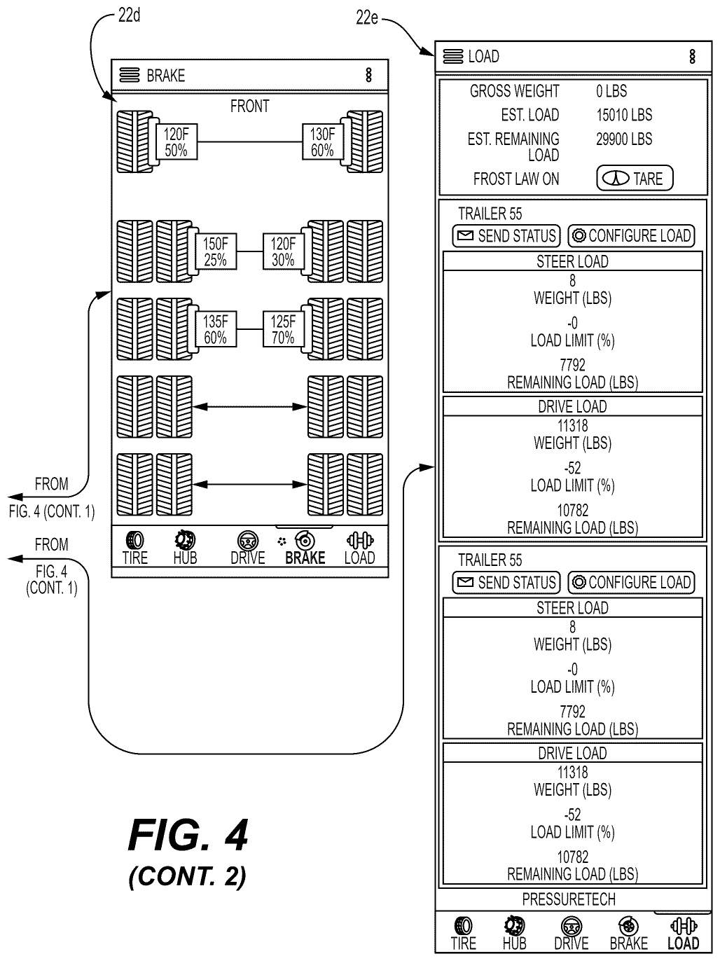

FIG. 4 presents a first set of screens of the app., in accordance with aspects of the present disclosure. FIG. 4 shows each of: the tire status page 22b, the hub status page 22c, the dashboard page 22a, the brake status page 22d, and the load status screen 22e; each for a particular configuration of the tractor/trailer 10, 14.

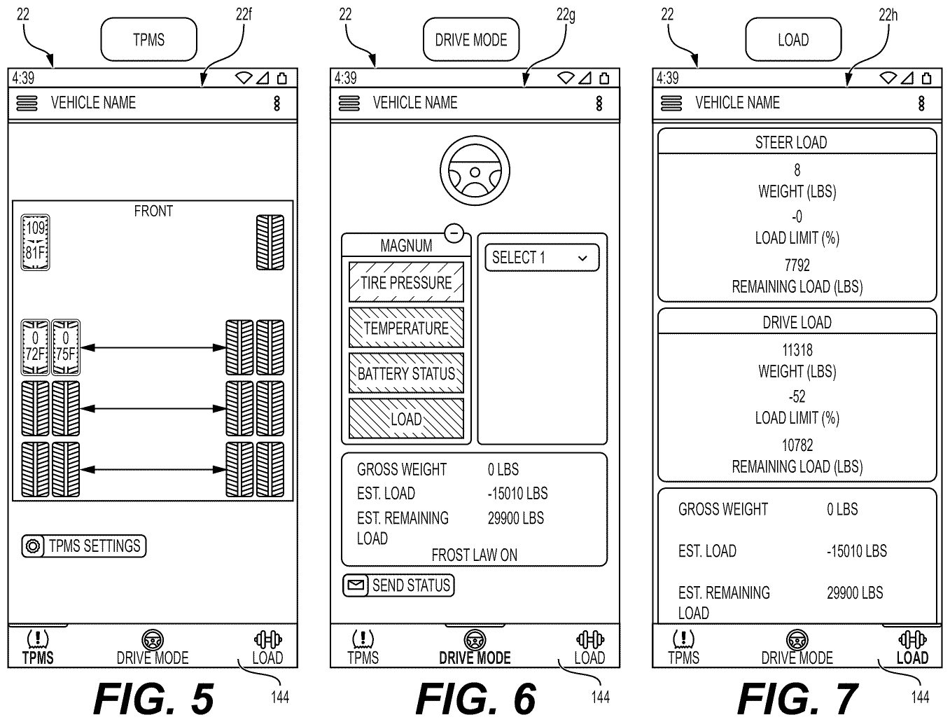

FIGS. 5-7 present a second set of screens of the app., and for a different vehicle, such as a box truck having four axles. FIG. 5 shows another tire status page 22f, showing the axle statuses and measured temperatures and pressures of three of the tires. FIG. 6 shows another dashboard page 22g, which may be similar to the dashboard page 22a shown on FIG. 3, except with different indicators that are specific to this different vehicle. FIG. 7 shows another load status screen 22h, which may be similar to the load status screen 22e shown on FIG. 4, except with different indicators that are specific to this different vehicle.

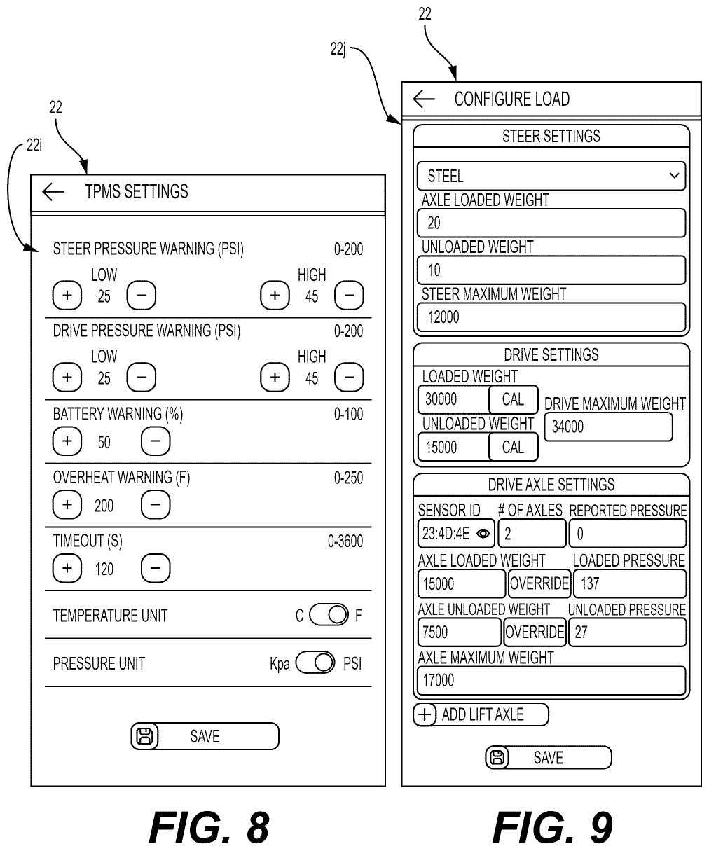

FIG. 8 presents a TPMS setting screen 22i of the app., in accordance with aspects of the present disclosure. The TPMS setting screen 22i includes settings for an operator to adjust warning pressures for each of steering tires and drive tires, independently. The TPMS setting screen 22i includes settings for an operator to adjust a battery warning, overheating warnings, and timeout warnings.

FIG. 9 presents a load configuration setting screen 22j of the app., in accordance with aspects of the present disclosure. The load configuration setting screen 22j includes various settings that pertain to loading of the vehicle.

In some embodiments, the operator may be prohibited from adjusting one or more of the settings, such as the TPMS setting screen 22i and/or the load configuration setting screen 22j. Those settings may be available only remotely via the a fleet command center computer 72 and/or with particular permissions or password access, such as for maintenance technicians.

Each of the screens or pages 22a - 22j may be presented at any given time on the mobile device 22, such as a smartphone or tablet, depending on a given vehicle configuration.

In some embodiments, the mobile device 22 may include a camera 28 that can be used to take photos and/or video of the tractor/trailer 10, 14. The photos and/or video may then be processed to determine the number of axles and tires and the relative distance between the axles, and the types of suspension. That information can be fed to a vehicle model calculator to determine the optimal pressures and heights for the suspension to achieve optimal loading. In some embodiments, the system of the present disclosure can even recommend changing the axle locations to improve load carrying capability. The app may prompt the user to confirm axle function, including which axles are liftable axles, and which axles have independent control. This information may be used to enable configuration of the vehicle in the mobile app so the user would not have to manually enter, reducing errors and easing the installation process. So this should significantly reduce the complexity of installation, and offer the user new valuable insights into how to optimize their vehicle. Optimal lift axle pressures may be defined for each axle and changes to the vehicle may be recommended to further optimize. Taking this one step earlier in the process, a customer may upload or otherwise provide photos and/or video of their vehicle or vehicles, and such photos and/or video may be used to quote a full system of sensors and solutions for their vehicle.

In some embodiments, the app may be configurable to enable/disable systems that are not purchased - for example a customer may only purchase the TPMS Tire monitoring sensors, so the App would only show TIRE, not Hub, Brakes, Load, Height. In this way the app. can be simple for basic customers, and expandable to allow customers to enhance/upgrade their experience by purchasing additional systems and enabling them in the app.

In some embodiments, the app. may be configured to synchronize any system settings between the mobile device 22 and the server 60. Any set point or calibrations made on the mobile device 22 may be stored in a persistent memory, such as in a database. A centralized database, which may be called a fleet master database, may store configuration data and settings regarding a plurality of vehicles. The fleet master database may include data regarding each vehicle with its sensor locations/assignments and all configuration/settings. In some embodiments, some settings, such as minimum tire pressures for an alert, may be locked so they cannot be changed.

The present disclosure may provide for two distinct product types to be combined and controlled by one unified app. on a mobile device 22. Those two distinct product types include an integrated iAir controller that incorporates electronics, sensors, and pneumatic control into one automotive-grade controller. The iAir controller may include, for example, a controller as set forth in U.S. Pat. No. 11,571,941 and/or U.S. Patent Application publication 2023/0150329, which are each hereby incorporated by reference. The two distinct product types also include a wireless sensor platform for monitoring one or more sensors via short-range wireless data connection, such as using Bluetooth. The wireless sensor platform may include a receiver/relay that is configured to receive and collect data from a plurality of different sensors, such as sensors for monitoring tire pressure, onboard scales, temperature, acceleration, proximity, and/or other sensors. For example, the wireless sensor platform sensor platform may include a system and/or apparatus as set forth in U.S. Patent Application publication 2022/0234397, which is hereby incorporated by reference. The two product lines may communicate on Bluetooth and interface with mobile Apps. The system and app. of the present disclosure may simplify electrification of vehicle systems.

The app. running on the mobile device 22 may interface via Bluetooth to several different sensors and systems, allowing a customer to easily configure each system, view data, and control functions. The main “Drive” screen brings all the systems together to make a single User interface that has “health/access buttons” for each system on each vehicle (truck+trailer). Each button can be green/yellow/red to show status, allowing the User a quick snapshot of vehicle health: If all green, drive—the vehicle is OK; if yellow, monitor to see if ok; if red, pull over and check (tire blowout, hub overheat, overloaded, etc.)

The system and app. of the present disclosure provides several beneficial features not previously available. For example, the system and app. of the present disclosure provides a dashboard page, which may also be called a “Drive Mode” page. The dashboard page brings together the critical systems of both truck and trailer into one screen, giving a driver/technician the ability to “see” system health in one glance, with green-yellow-red marking to alert to any issue. This “information integration” into one screen allows the driver to one-glance and confirm systems are Green, instead of having to open separate interfaces for various subsystems. The system and app. of the present disclosure provides a “system health button/flag” per system, boxed graphically to represent a truck and trailer - providing a simplified snapshot of total vehicle health, where the user can touch the button that has an issue (yellow or red flag) and see more detail when needed.

The system and app. of the present disclosure may utilize Bluetooth (BT) sensors and control systems to allow easy interface from BT-enabled mobile devices using app., where App includes ability to configure device+alert settings, assign sensor locations on vehicle, for more than 1 system—where the app. communicates independently to each system and then coalesces data and control into one interface.

The system and app. of the present disclosure may be configurable to enable/disable systems that are not purchased per vehicle—for example a customer may only purchase the TPMS Tire monitoring sensors for his or her pickup truck, so the app. would only show TIRE, not Hub, Brakes, Load, Height. But on his or her RV trailer, the customer installed TPMS and Load. Thus, the app. may show TIRE and LOAD for the Trailer. In this way the app. can be simple for basic customers, and expandable to allow customers to enhance/upgrade their experience by purchasing additional systems and enabling them in the app.

The system and app. of the present disclosure can send data to cloud or email: critical alerts or regular data uploads can be sent to email or to a cloud server to enable Fleet command alerts/trends/maintenance planning. This feature enables fleets to not need separate telematics systems like GeoTab or Samsara.

The system and app. of the present disclosure provides for user-adjustable configuration: commercial trucks and trailers vary significantly—from single rear axles to 8 axles with multiple liftable axles, single tires to dual tires per wheel end, etc. Configuring each vehicle in an App gets complicated and requires a technician with training and skill. We can utilize the mobile device camera to take photos of the vehicle and then process the images to determine the number of axles and tires and the relative distance between the axles, and the types of suspension. That information can be fed to a vehicle model calculator to determine the optimal pressures, max weights and heights per axle to achieve optimal loading. The system may even recommend changing axle locations to improve load carrying capability. The app may prompt the user to confirm axle function, including which axles are liftable axles, and which axles have independent control. This information could drive configuration of the vehicle in the mobile app so the user would not have to manually enter, reducing errors and easing the installation process. So, the system and app. of the present disclosure can significantly reduce the complexity of installation and offer the user new valuable insights into how to optimize their vehicle.

The system and app. of the present disclosure provides for automatic synchronization between a semi-tractor (also called a truck) and one or more trailers: over-the-road commercial vehicles may operate with trucks moving many trailers where one truck interfaces with many trailers. To ease driver operation and minimize complexity, the app. can switch trailer automatically: The app. can detect changes in data from previous state (previous trailer), identifying new sensor readings that were not previously present. The app. can search database to find trailer vehicle with said sensor(s), and upload that trailer vehicle configuration into the app. and Drive Mode, automatically syncing to the new trailer.

The system and app. of the present disclosure also provides vehicle system setup coaching: with the Load measuring/estimating aspect of the app, an operator or supervisor can “watch” as the vehicle is loaded and see that lift axles may be improperly pressurized too high or low, and “coach” the user to change the target regulator pressures. For example, if lift axles are deployed to too high pressure, they can lift the trailer off the primary suspension and truck, relieving the truck of load compared to an unloaded condition. This is bad—a loaded truck and trailer should distribute the load across all axles as evenly as possible, and should not unload the truck that needs to have tire traction for drive, braking, and steering. In a worst case, where the trailer unloads the truck significantly, this can lead to safety issues like higher potential for jack-knifing and longer braking distances. The app. can define optimal lift axle pressures for each axle and recommend changes to the vehicle to further optimize.

In accordance with an aspect of the present disclosure, a customer could download the app. to a mobile device and then use the mobile device with the app. to take photos of their vehicle(s). The app. may be configured to use the photos to provide the potential customer with a quote for a full suite of sensors and control systems for their vehicle. The customer could check one or more box(es) of the product(s) wanted, purchase, and the app. would self-configure for the vehicle(s). For example, a customer with truck and trailer could take a photo, the app. would determine, based on the photos, a number of tires and axles, request confirmation of each axle (air suspension or steel suspension, liftable or not, dual tires or single tires, etc). Once the customer confirms, the app. may define a number of TPMS sensors needed, load sensors needed, control systems available etc., and present the list of needed or recommended devices to the potential customer. The customer would then check the boxes of products they want—TPMS only for Truck, TPMS and Load for trailer. Once purchased, the app. may self-configure the truck and trailer separately, assigning TPMS to truck and TPMS and Load sensors and/or actuators to the trailer. Once products arrive to the customer, the customer then opens the app., and the app. guides installation per vehicle.

The app. may interface with many different systems in a vehicle. Such systems may include:
Tire: tire Pressure monitoring and/or inflation control;
Hub: bearing temperature monitoring and acceleration monitoring;
Brake: brake pad wear and temperature monitoring;
Load: suspension sensors and/or lift/height control systems;
Lift: Auto-deployment of lift axles;
Height: electronic height control system; and/or
Rig: rigging chains/strap tension systems.
   Note: each vehicle can have different systems installed—the app. may configure each vehicle independently to accommodate this. Some instances can have both sensors and control system—for example TIRE can allow a user to interface with both the automatic tire inflation control system and TPMS per tire.

A Range Extender may be employed to gather sensor and system signals and repeat them with extra transmission power to reach the mobile device in the truck cab/cockpit. Once truck and trailer data received by mobile device, it can then send email alerts or update cloud.

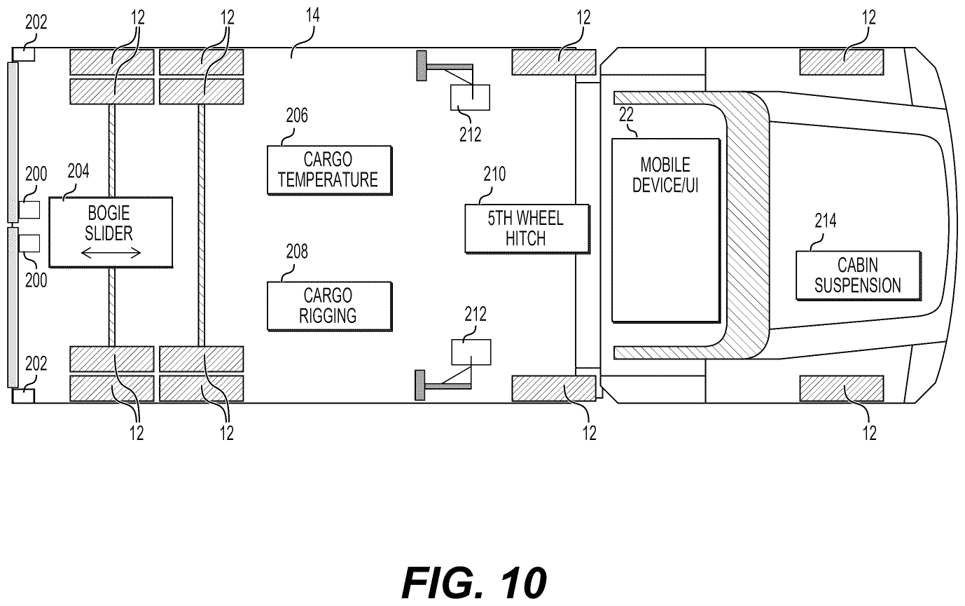

FIG. 10 presents a schematic diagram of a semi-tractor and trailer, showing additional sensors and/or actuators monitored by a system, in accordance with aspects of the present disclosure. The app on the mobile device 22 can interface with additional sensors and/or actuators to better cover the critical systems on commercial vehicles, such as the tractor/trailer 10, 14 shown, and which include: door sensors 200, light sensors 202, a bogie slider sensor 204, a cargo temperature sensor 206, cargo rigging sensors 208, a hitch controller 210, landing gear actuators 212, and a cab suspension height controller 214. The door sensors 200 may monitor one or more doors to confirm that the doors are closed and/or latched. The light sensors 202 may monitor that one or more brake lights, side-marker lights, and/or turn signal indicator lights are functional. The bogie slider sensor 204 may measure a position of a bogie slider for a slidable axle. Additionally or alternatively, the bogie slider sensor 204 may sense the bogie slider being in a given position or having a latched or locked condition. The cargo temperature sensor 206 may include one or more sensors for monitoring cargo, such as internal spaces of refrigerated trailers. The cargo rigging sensors 208 may measure presence or other features of cargo rigging equipment, such as tension of rigging straps, to confirm that the cargo rigging, such as straps and//or chains) are installed and tight, and that the cargo rigging remains in a given configuration during transport. The hitch controller 210 may monitor and/or control a 5th wheel hitch latch to confirm the truck-to-trailer hitch connection is secure. The landing gear actuators 212 may monitor and/or control retractable landing gear legs to verify that the landing gear legs are retracted prior to driving and/or to confirm that the landing gear legs are locked into a deployed position prior to decoupling the truck from the trailer. The cab suspension height controller 214 may monitor and/or control components of a cab air suspension system.

In some embodiments, some or all of these additional sensors and/or actuators 200, 202, 204, 206, 208, 210, 212, 214 may be connected to one of the ECUs 30, 40, 50. Alternatively or additionally, some or all of the additional sensors may communicate directly with the mobile device and/or via one or more additional ECUs, such as a body control module of the tractor/trailer 10, 14.

The present disclosure provides a mobile device app. with Bluetooth wireless networking that interfaces wirelessly with more than one external sensor and/or control system, combining the status of multiple subsystems into a single dashboard page, allowing users to view alerts and interactivity allowing user to touch and see greater detail as needed.

In some embodiments, the single dashboard page presents green/yellow/red alert status indicators for each of the subsystems. In some embodiments, the mobile device app. is configured to cause automatic alert emails to be sent in response to predetermined conditions, such as detection of one or more faults in the subsystems of the vehicle. In some embodiments, the mobile device app. is configured to automatically transmit updates, such as sensor data and/or system status data to a remote server.

In some embodiments, the single dashboard page simultaneously presents status indicators for two different vehicles on the single dashboard page. The two different vehicles may include, for example, two trailers or a semi-tractor and a trailer that are physically coupled together. The two different vehicles may be separately configured utilizing the app.

In some embodiments, a system may measure vehicle weight/load, and combine truck and trailer loads are combined into a gross weight, which may be displayed by the mobile device app.

In some embodiments, the ap. may automatically sync new vehicle configuration based on presence of new sensor signals, where the app. searches a database for vehicle with said new sensors and uploads that new vehicle configuration into the mobile device app., assigning it as the new vehicle the single dashboard page.

The present disclosure also provides a mobile device app with Bluetooth that interfaces wirelessly with more than one external sensor and/or control system, on more than one vehicle, where each vehicle is separately configured, system status is communicated, and alert emails are sent automatically.

The present disclosure also provides a mobile device app with Bluetooth that interfaces wirelessly with more than one external sensor and/or control system, on a truck and trailer, where trailer data is communicated from trailer to truck cab-mounted mobile device by way of wireless Range Extender.

The mobile device 22 is located in the vehicle and is in communication with a plurality of sensors for receiving data regarding at least one physical characteristic of the electro-pneumatic system. The mobile device 22 may receive the data directly from one or more sensors. Alternatively or additionally, the mobile device 22 may receive the data via a connection to one or more ECUs 30, 40, 50 located onboard the vehicle. The mobile device may also be programmed or otherwise configured to transmit status data, such as data regarding the sensed physical characteristics of the electro-pneumatic system, to a remote computer, such as the server 60 and/or the fleet command center computer 72 via the network 66. The status data may include actual measured values of the physical characteristics. Alternatively or additionally, the status data may include status indicators, such as a data value regarding one or more sensors or subsystems to signal that a measured value or subsystem is okay or in an alert or faulted condition.

Additionally or alternatively, a remote computer, such as the fleet command center computer 72 may include a user interface that presents a dashboard page that is similar or identical to one or more of the dashboard pages 22a, 22g described herein. The remote computer may also change a visual appearance of each status indicator on the dashboard page, such as with Red/Green/Yellow colors to indicate a condition of the corresponding system.

The remote computer may also detect a user selection of each status indicator on the dashboard page, such as by detecting a selection using a touchscreen, keyboard, and/or mouse click. The remote computer may also present a system detail screen for a given subsystem in response to detecting the user selection of a corresponding status indicator of the plurality of status indicators. The system detail screens may be similar or identical to the screens 22b, 22c, 22d, 22e, 22f, 22h, described, above. However, the remote computer may present a different arrangement of the detail screens, which may include data for more than one vehicle, and/or with additional features or settings that may not be available on the mobile device 22.

In some embodiments, the mobile device 22 may not present the dashboard page 22a, 22g. For example, some fleet operators may desire to minimize visual data presented in order to minimize a risk of distracting a vehicle operator. The mobile device 22 may still function as a data relay, for transmitting data from the sensors and/or ECUs on the vehicle to the server 60 and/or the fleet command center computer 72. In some embodiments, the mobile device 22 may present a visual, audio, and/or other indicator, in case a warning or alarm condition is detected with an associated system, such as an electro-pneumatic control system on the vehicle. For example, the system may be configured to cause the mobile device 22 to only alert the operator in case of certain alarms or conditions that may impact safety or which require immediate attention. Examples of such alarms or conditions may include, for example: a tire pressure measurement indicating significant air leak or blowout, an open or unsecured door on a trailer 14, cargo rigging that has become unsecured, a hitch latch that is unsecured, or landing gear that is unsecured. These are merely examples, and the exact alarms or conditions to be communicated to the operator via the mobile device 22 may depend on the specific hardware configuration of the vehicle and/or system settings that may be controlled by a system administrator, such as a fleet manager.

The present disclosure also provides an electro-pneumatic monitoring system. The electro-pneumatic monitoring system includes: a plurality of sensors, each configured to detect at least one physical characteristic of an electro-pneumatic system of a vehicle; and a mobile device located in the vehicle in communication with the plurality of sensors for receiving data regarding the at least one physical characteristic of the electro-pneumatic system. The mobile device is configured to transmit data to a remote computer. The remote computer includes a user interface presenting a dashboard page having a plurality of status indicators, each representing a corresponding system of the vehicle. The remote computer is configured to change a visual appearance of each status indicator of the plurality of status indicators to indicate a condition of the corresponding system.

In some embodiments, the mobile device 22 may be used to configure devices, such as sensors, on a vehicle. For example, a technician may use the camera 28 to capture a sensor identifier of a new device. The technician may then use the user interface of the mobile device 22 to assign the new device to a particular position on the vehicle, such as a particular wheel or a particular location and/or function. The sensor identifier may include a Quick Response (QR) code that may be printed or otherwise affixed to a particular sensor. However, other types of identifiers may be used, such as barcodes or radio-frequency identification (RFID) tags. Alternatively, the technician can manually input the sensor identifier into the mobile device 22.

The system, methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or alternatively, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices as well as heterogeneous combinations of processors processor architectures, or combinations of different hardware and software, or any other machine capable of executing program instructions.

Thus, in one aspect, each method described above and combinations thereof may be embodied in computer executable code that, when executing on one or more computing devices performs the steps thereof. In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

A computer, processor, controller, microcontroller, electronic control unit, or other computing device or devices should be understood to mean any combination of one or more computing hardware devices, which may operate independently and/or in coordination to perform one or more computing or other data processing functions.

Obviously, many modifications and variations of the present invention are possible in light of the above teachings and may be practiced otherwise than as specifically described while within the scope of the appended claims. These antecedent recitations should be interpreted to cover any combination in which the inventive novelty exercises its utility. The use of the word “said” in the apparatus claims refers to an antecedent that is a positive recitation meant to be included in the coverage of the claims whereas the word “the” precedes a word not meant to be included in the coverage of the claims. In addition, the reference numerals in the claims are merely for convenience and are not to be read in any way as limiting.

What is claimed is:

1. An electro-pneumatic control system for a vehicle, comprising:
a plurality of sensors, each configured to detect at least one physical characteristic of the electro-pneumatic control system; and
a mobile device in communication with the plurality of sensors for receiving data regarding the at least one physical characteristic of the electro-pneumatic control system, the mobile device including a user interface presenting a dashboard page having a plurality of status indicators, each representing a corresponding subsystem of the vehicle,
wherein the mobile device is configured to change a visual appearance of each status indicator of the plurality of status indicators to indicate a condition of the corresponding subsystem of the vehicle,
wherein the mobile device is configured to detect a user selection of each status indicator of the plurality of status indicators,
wherein the mobile device is further configured to present a system detail screen for a given subsystem in response to detecting the user selection of a corresponding status indicator of the plurality of status indicators.

2. The electro-pneumatic control system of claim 1, wherein the mobile device is configured to receive the data regarding the at least one physical characteristic of the electro-pneumatic control system, via a wireless communications interface.

3. The electro-pneumatic control system of claim 1, wherein the mobile device is further configured to present an input control for receiving a revised setting value, wherein the revised setting value controls at least one of: a calibration or an alarm threshold value of the at least one physical characteristic of the electro-pneumatic control system, and
wherein the mobile device is further configured to transmit the revised setting value to a remote server via a wireless data network.

4. The electro-pneumatic control system of claim 1, wherein the mobile device is further configured to transmit the data regarding the at least one physical characteristic of the electro-pneumatic control system to a remote server via a wireless data network.

5. The electro-pneumatic control system of claim 1, wherein the mobile device is configured to change the visual appearance of each status indicator of the plurality of status indicators between each of:
a first color to indicate the condition of the corresponding subsystem of the vehicle as being good,
a second color to indicate the corresponding subsystem of the vehicle as having a warning condition, and
a third color to indicate the corresponding subsystem of the vehicle having a faulted condition.

6. The electro-pneumatic control system of claim 1, wherein the electro-pneumatic control system is further configured to generate an alert in response to the at least one physical characteristic of the electro-pneumatic control system exceeding a corresponding threshold value.

7. The electro-pneumatic control system of claim 6, wherein the system detail screen includes an input control for adjusting the corresponding threshold value.

8. The electro-pneumatic control system of claim 6, generating the alert includes automatically sending an email with content regarding the at least one physical characteristic of the electro-pneumatic control system exceeding the corresponding threshold value.

9. The electro-pneumatic control system of claim 1, wherein the dashboard page of the user interface presents the plurality of status indicators to simultaneously indicate statuses of subsystems of two different vehicles.

10. The electro-pneumatic control system of claim 9, wherein the two different vehicles include a semi-tractor and a trailer coupled to the semi-tractor.

11. The electro-pneumatic control system of claim 10, wherein the system is further configured to determine an actual weight of each of the semi-tractor and a trailer coupled to the semi-tractor, and wherein the user interface further presents a total weight including the actual weight of each of the semi-tractor and the trailer coupled to the semi-tractor.

12. The electro-pneumatic control system of claim 1, wherein the mobile device is configured to: detect a presence of one or more new sensors, query a database for a vehicle associated with the new sensors, and receive, from the database, a new vehicle configuration dataset regarding the vehicle associated with the new sensors.

13. The electro-pneumatic control system of claim 12, wherein the mobile device is further configured to: generate the dashboard page with the plurality of status indicators based on the new vehicle configuration dataset.

14. The electro-pneumatic control system of claim 1, further including an electronic control unit located onboard the vehicle and in functional communication with at least one sensor of the plurality of sensors,
wherein the mobile device is in direct with the electronic control unit via a wireless communications interface, and
wherein the electronic control unit is configured to transmit the data regarding the at least one physical characteristic of the electro-pneumatic control system to the mobile device.

15. The electro-pneumatic control system of claim 1, wherein the subsystems represented by the plurality of status indicators include at least two of: tire pressure, hubs, brakes, and load.

16. An electro-pneumatic control system for a vehicle, comprising:
a first electronic control unit configured to control a first pneumatic function;
a second electronic control unit configured to control a second pneumatic function; and
a mobile device in communication with each of the first electronic control unit and the second electronic control unit for receiving data regarding each of the first pneumatic function and the second pneumatic function, the mobile device including a user interface presenting a dashboard page having a plurality of status indicators, each representing a corresponding system,
wherein the mobile device is configured to change a visual appearance of each status indicator of the plurality of status indicators to indicate a condition of the corresponding system.

17. The electro-pneumatic control system of claim 16, wherein at least one of the first pneumatic function or the second pneumatic function includes at least one of:
lifting, height, and/or load distribution in a trailer;
tire pressure in the trailer;
lifting, height, and/or load distribution in a semi-tractor pulling the trailer; or
tire pressure in the semi-tractor pulling the trailer.

18. An electro-pneumatic monitoring system, comprising:
a plurality of sensors, each configured to detect at least one physical characteristic of an electro-pneumatic system of a vehicle; and
a mobile device located in the vehicle in communication with the plurality of sensors for receiving data regarding the at least one physical characteristic of the electro-pneumatic system, wherein the mobile device is configured to transmit status data regarding the electro-pneumatic system to a remote computer,
wherein the remote computer includes a user interface presenting a dashboard page having a plurality of status indicators, each representing a corresponding system of the vehicle,
wherein the remote computer is configured to change a visual appearance of each status indicator of the plurality of status indicators to indicate a condition of the corresponding system.

19. The electro-pneumatic monitoring system of claim 18, wherein the remote computer is configured to detect a user selection of each status indicator of the plurality of status indicators, and
wherein the remote computer is further configured to present a system detail screen for a given subsystem in response to detecting the user selection of a corresponding status indicator of the plurality of status indicators.

20. The electro-pneumatic monitoring system of claim 18, further comprising:
a first electronic control unit configured to control a first pneumatic function of the vehicle; and
a second electronic control unit configured to control a second pneumatic function of the vehicle,
wherein the plurality of sensors are each in functional communication with at least one of the first electronic control unit or the second electronic control unit, and
wherein the mobile device is in communication with each of the first electronic control unit and the second electronic control unit for receiving the data regarding the at least one physical characteristic of the electro-pneumatic system.
